(19) United States
(12) Patent Application Publication
(10) Pub. No.: US 2009/0100886 A1
(43) Pub. Date: Apr. 23, 2009

(54) Closing mechanism for vehicles

(75) Inventors: Udo Orzech, Wuppertal (DE); Rolf Kamps, Wuppertal (DE); Hans-Gunter Kaiser, Wuppertal (DE); Jorg Berghahn, Gelsenkirchen (DE); Dirk Ruppach, Bochum (DE)

Correspondence Address: Friedrich Kueffner, Suite 910, 317 Madison Avenue, New York, NY, 10017, US

(73) Assignee: Huf Hulsbeck & Furst GmbH & Co. KG

(21) Appl. No.: 12/288,078

(22) Filed: Oct. 16, 2008

(30) Foreign Application Priority Data
Oct. 17, 2007 (DE) 10 2007 050 032.9
Nov. 29, 2007 (DE) 10 2007 057 560.4

(51) Int. Cl. E05B 65/36

(52) U.S. Cl. 70/265

(57) ABSTRACT

A closing mechanism with a lock which contains both a rotatably supported latch and a pivotably supported pawl, which is spring-loaded toward the latch. The latch is in an open position when the door is open, and, when the door is being closed, it moves first into a prelatching position, in which the pawl engages with a prelatching notch on the latch. A closing aid moves the latch from its prelatching position into a main latching position, in which the pawl is supported on the main latching notch of the latch. When the door is opened, before the release or during the release, the closing aid be activated again not in the same direction as the preceding closing movement but rather in the opposite direction. As a result, the same component, namely, the closing aid, is used to move the latch gradually and gently back into its open position.

### BACKGROUND OF THE INVENTION

1. Field of the Invention

The present invention relates to a closing mechanism with a movable part of a vehicle such as a (hinged) lid or door and with a resting part of the vehicle, namely, the vehicle body,
consisting of a lock on the one part of the vehicle and a closing part on the other part;
where the lock comprises a rotatably supported latch and a pivotably supported pawl;
the latch has a receptacle for a closing part and both a prelatching notch and a main latching notch for the engagement of the pawl;
the pawl is spring-loaded in the direction toward the latch; and
the latch is in an open position when the (hinged) lid or door is open, and, when the (hinged) lid or door is being closed, the latch moves initially into a prelatching position, in which the pawl engages in the prelatching notch of the latch;
with a motorized closing aid, which, during the closing phase, moves the latch by motor power onward out of the prelatching position, thus bringing the latch into the main latching position, in which the pawl is supported on the main latching notch of the latch; and
with an actuator, acting on the pawl, to open the (hinged) lid or door;
where, upon activation of the actuator, the pawl is lifted out of the main latching notch, which thus releases the latch; and the released latch leaves its main latching position and returns to its open position, in which the (hinged) lid or door is open, wherein
while the latch is in the main latching position closed, the closing aid is activated again before the release or during the release of the latch by the pawl and, during the return movement phase, moves the latch gradually back into its open position in the direction opposite that of the preceding closing phase. The lock belonging to the closing mechanism includes a latch, a pawl, and at least one motorized closing aid. When the (hinged) lid or door is closed, the latch arrives first in a prelatching position, in which the pawl drops into a prelatching notch. Then, with the help of sensors or the like, the closing aid is activated, which then initiates the closing phase. During this closing phase, the closing aid moves the latch out of its prelatching position and into the main latching position, at which point the pawl drops into the main latching notch. The (hinged) lid or door is now completely closed.

2. Description of the Related Art

A closing mechanism of this type is known from DE 102 06 813 A1. During the closing phase, the elastic seals between the (hinged) lid or door and the vehicle body are compressed. Springs are also present, which try to push the (hinged) lid or door into its open position. The (hinged) lid is thus under tension. To open the (hinged) lid, an actuator is used, which lifts the pawl out of its engaged position in the main latching notch of the latch. In certain cases, this can also be done by a so-called motorized opening aid. Because of the previously mentioned tension, the (hinged) lid or door springs open abruptly and produce an unpleasant noise, which can be disturbing.

### SUMMARY OF THE INVENTION

The invention is based on the object of developing an inexpensive closing mechanism of the type indicated in the introductory clause of Claim 1, which makes it possible for the (hinged) lid or door to be opened conveniently and gently. This is achieved according to the invention by the measures described in Claim 1, to which the following special meaning attaches.

The invention makes use of a closing aid, i.e., a device which serves to pull the door or (hinged) lid closed, and gives it a new function, namely, that of opening the lid or door in a convenient manner in that the closing aid is also operated during the opening phase. A component which is already present, namely, the closing aid, thus acquires a double function through the invention. The first, conventional function of the closing aid is, as previously mentioned, to move the pawl out of the prelatching position in the latch into the main latching position during the closing phase. The second, new function of the closing aid is to move the latch in a defined manner gently back into its open position in the direction opposite that of the preceding closing phase. The motor of the closing aid then acts in opposition to the tension being exerted on the (hinged) lid or door. The return movement can be controlled very precisely by sensors, which are inexpensive and occupy very little space, and appropriate electronic software. Because the latch is returned to the open position by the motor of the closing aid acting in the opposite direction, no disturbing opening noises are produced. The forces acting on the seals and springs are relaxed slowly during the return movement phase of the closing aid. The (hinged) lid or door open in a controlled manner by way of the rotary latch and the closing part which engages in it.

The various features of novelty which characterize the invention are pointed out with particularity in the claims annexed to and forming a part of the disclosure. For a better understanding of the invention, its operating advantages, specific objects attained by its use, reference should be had to the drawing and descriptive matter in which there are illustrated and described preferred embodiments of the invention.

### BRIEF DESCRIPTION OF THE DRAWING

### In the Drawings:

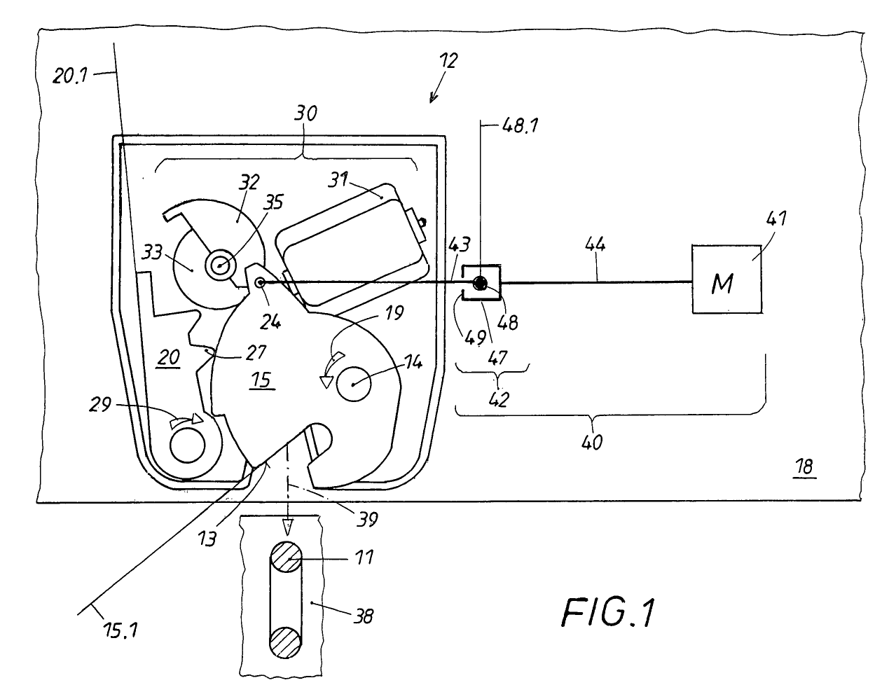

FIG. 1 shows the latch of the lock in the open position, which is present while the hatchback is open, the part of the lock mounted on the vehicle body still being completely disengaged;

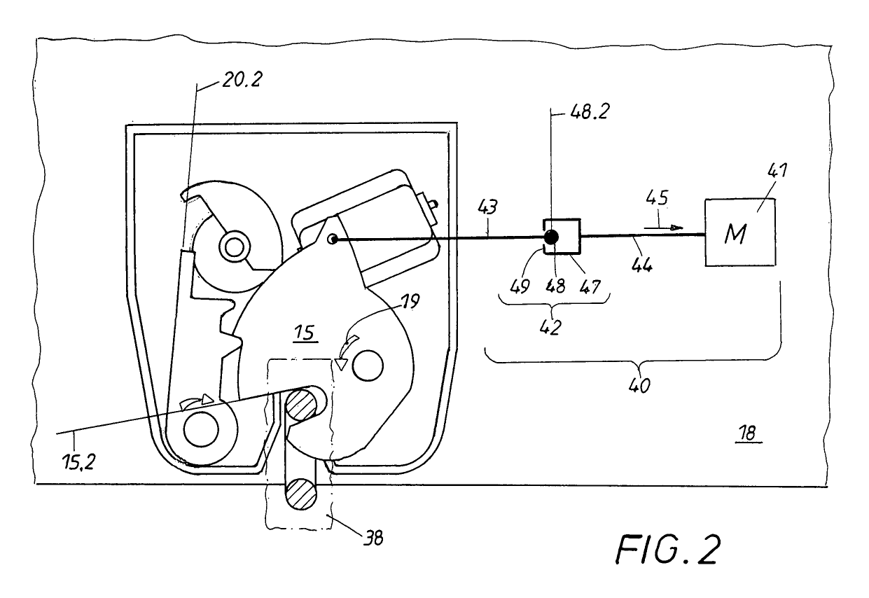

FIG. 2 shows the same closing mechanism at the time when the latch is in its prelatching position and a closing aid begins to operate, thus initiating the closing phase of the latch and thus of the (hinged) lid;

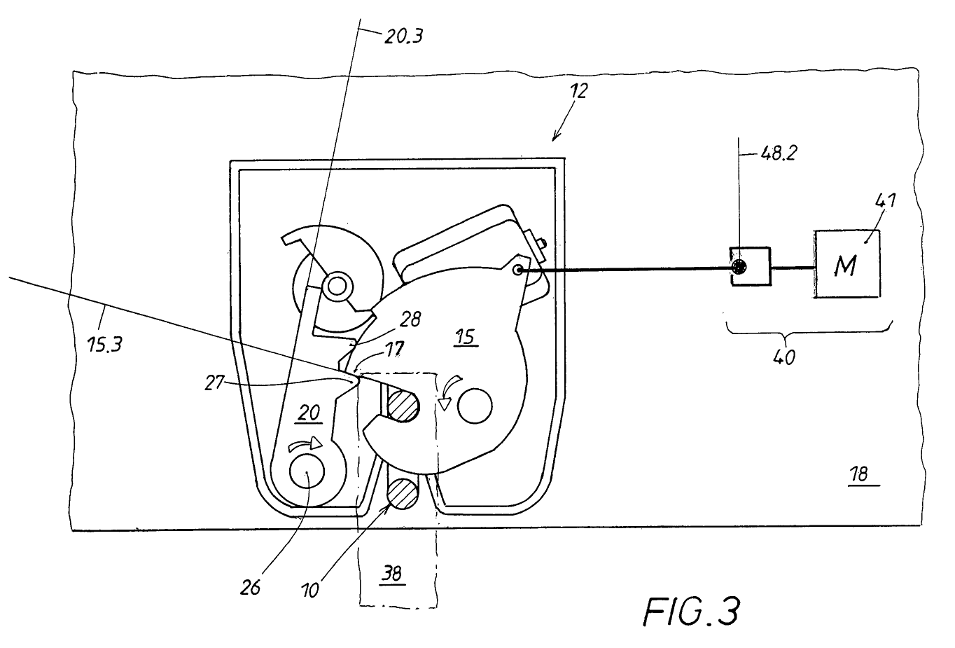

FIG. 3 illustrates the final part of the closing phase, where the latch has just reached the main latching position and been secured there by a pawl;

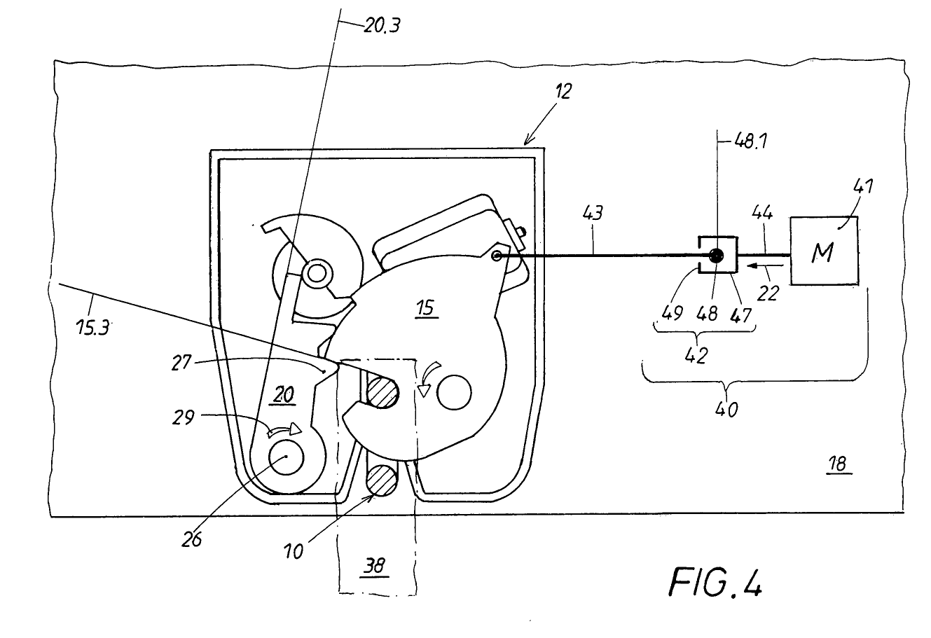

FIG. 4 shows the same main latching position as that of FIG. 3, but here the closing aid has relaxed after the final closed state of the hatchback has been reached;

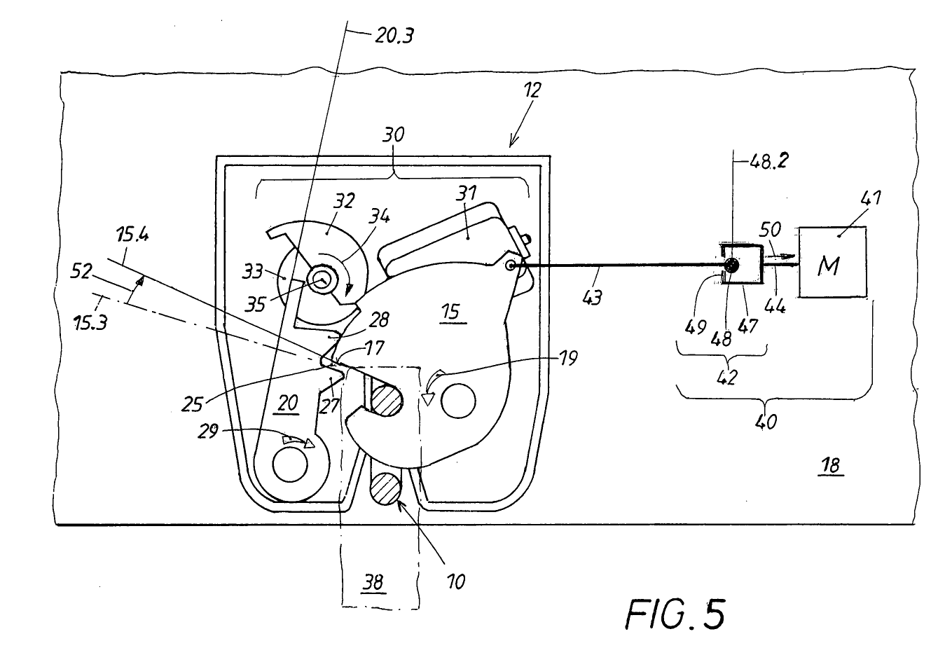

FIG. 5 shows an overstroke phase of the latch, which occurs before the start of the return phase and which releases the load on the pawl, thus allowing it be lifted easily; and

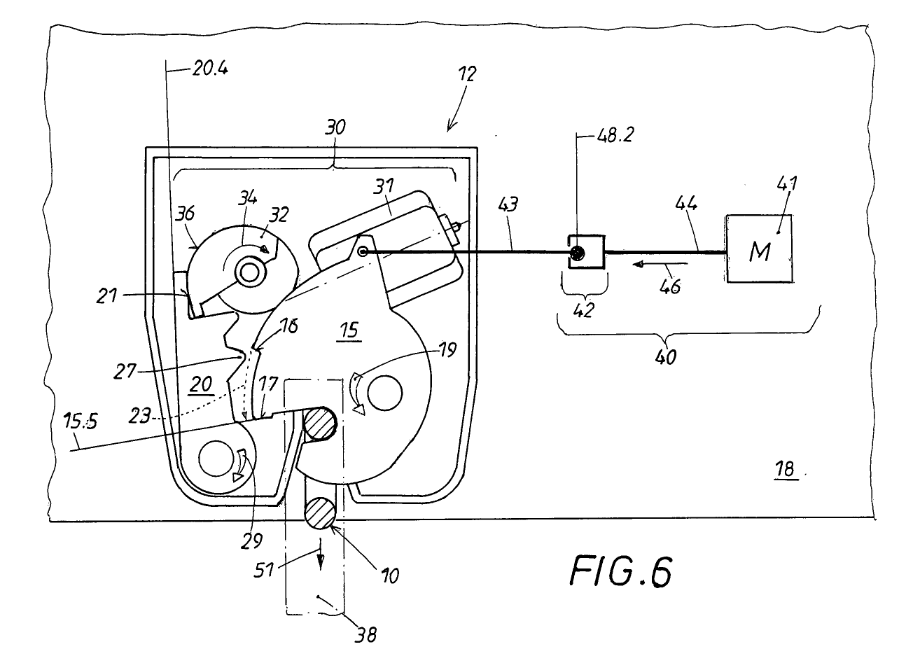

FIG. 6 explains how the closing aid works during the inventive return phase, in which the latch is gradually returned to its open position in the direction opposite that of the closing and overstroke movement of FIGS. 2 and 5.

### DETAILED DESCRIPTION OF THE INVENTION

The lock 12 is located in the present case on the hatchback of a motor vehicle, only part 18 of which is shown in FIGS. 1-6. The housing of the lock 12 is shown open in all of the figures, for which reason the following lock parts can be seen.

First there is a pawl 20, which, when the (hinged) lid 18 is open, is located in the standby position illustrated by the auxiliary line 20.1 in FIG. 1, where it is supported by its catch projection 27 on the periphery of a latch 15. The pawl 20 is mounted in the lock housing with freedom to pivot around an axis 26. Another lock part is the latch 15, which is supported rotatably on an axis 14 and has a suitable contour around its periphery, namely, both a prelatching notch 16 and a main latching notch 17. The latch 15 is held in its open position, shown by the auxiliary line 15.1 in FIG. 1, by its own spring-loading 19, which is active in the present case, and a rotation stop (not shown).

A closing part 10 assigned to the lock 12 is designed here as a closing stirrup and is mounted on the body of the vehicle, only part 38 of which is shown. When the hatchback 18 is closed in the direction of the arrow 39, the forward leg 11 of the closing stirrup 10, starting from the position of FIG. 1, travels into a receptacle 13 in the latch 15 and moves the latch as far as the prelatching position shown in FIG. 2, as indicated by the auxiliary line 15.2.

The prelatching position 15.2 of the latch 15 is monitored by sensors, etc., which actuate a closing aid 60, illustrated schematically in the figures. The closing aid 40 is connected to a motor 41 by way of a transmission mechanism, e.g., rods 43, 44, where a coupling 42 can be installed in certain cases between the transmission mechanism 43, 44. To make it easier to understand the active and inactive states of the coupling 42, it is designed as a block guide 47, in which a (sliding) block 48 is guided. The block 48 is seated on the end of the first transmission rod 43, the inner end of which is hinged at 24 to the crank 15. At the point where the transmission rod 43 exits the block guide 47, the guide has an inner stop 49 for the (sliding) block 48. In the open position 15.1 of the latch, the transmission rod 43, 44 is slack. In the open position 15.1 of FIG. 1, the coupling 42 is therefore inactive. This is indicated in FIG. 1 by the fact that the (sliding) block 48 is a certain distance away from the inner stop 49 on the block guide 47. This position of the (sliding) block 48 is marked by an auxiliary line 48.1, which thus characterizes the “inactive state” of the coupling 42. The transmission mechanism 43, 44 is now relieved of load, and the closing aid 40 is in a relaxed, neutral position. In terms of the coupling 42, a “disengaged” state is present.

When the prelatching position 15.2 of FIG. 2 is reached, sensors and control means turn the motor 41 on. The motor 41 first moves the second transmission rod 44 in the direction of the arrow 45 in FIG. 2, as a result of which the coupling 42 is made active. That the coupling 42 is now active is indicated in FIG. 2 by the fact that the (sliding) block 48 is now resting against the inner stop 49. This situation is characterized in FIG. 2 by the auxiliary line 48.1 on the (sliding) block 48 opposite the inner stop 49. The line 48.1 therefore characterizes the “active” state of the coupling 42. Because the coupling 42 is now active, the closing movement 45 of the transmission rod 44 is transmitted to the transmission rod 43 belonging to the (sliding) block 48 and thus brings about a closing movement of that rod. As a result, the latch 15 is rotated even farther, against its spring-loading 19, to the position shown in FIG. 3, which is indicated by the auxiliary line 15.3. What we are seeing now is the “closing” phase of the closing aid 40. Seals between the car body 48 and (hinged) lid 18 are compressed. This tensioning work is performed by the motor 41 of the closing aid 40. Then the catch projection 27 of the pawl 20 drops behind the main latching notch 18 of the pawl. The closing stirrup 10 has reached its end position in the lock 12. In FIG. 3, the hatchback 18 is in its completely closed position. This is established by sensors, which act on the lock components and/or on the (hinged) lid 18. The sensors feed this information to an electrical control unit, which, on the basis of its electrical control program, first stops the motor 41. This limit situation is illustrated in FIG. 3. As can be seen on the basis of the auxiliary line 48.2, the coupling 42 is still inactive.

As FIG. 4 shows, however, the tensioned position 48.2 of FIG. 3 is not permanent; the motor control program now moves the motor 41 a certain distance backward in the direction of the arrow 22 of FIG. 4. Because of the control action of the linkage in the area of the coupling 42, however, only the motor-side transmission rod 44 moves back; the latch-side transmission rod 43 rests, because, as previously mentioned, the main latching position 15.3 of the latch 15 is still present in FIG. 4. Because of the previously mentioned relative movement of the two transmission rods 43, 44 with respect to each other, the closing aid 40 relaxes; the (sliding) block 48 is again a certain distance away from the inner stop 49. In FIG. 4, the disengaged position of the coupling 42 is again present, as indicated by the auxiliary line 48.1. The elastic forces of the compressed seals between the hatchback 18 and the link 38, i.e., forces which the closing stirrup 10 exerts on the latch 15, are absorbed by the catch projection 27 of the pawl and carried away via its pivot axis 26.

An actuator (not shown) is also provided to open the hatchback 18; it can be designed in any known manner. Thus, the actuator could be a component of a so-called ID transmitter, such as an electronic key, which is in the possession of an authorized person and which cooperates by remote control with a receiver present in the vehicle. This actuator, too, has a double function in the invention. A first function of the actuator is to cooperate directly or indirectly with the pawl 20. The second function of the actuator is associated with the present invention and consists in initiating a return movement of the closing aid, which will be described in greater detail on the basis of FIGS. 5 and 6.

In the present exemplary embodiment, the first function of the actuator is realized by a motorized opening aid 30. When the actuator is actuated, an electrical control unit puts an additional motor 31 into operation, which acts on a cam 32 by way of transmission parts, e.g., a worm and a worm gear 33. In the present case, the worm gear 33 and the cam 32 have a common axis 35. The motor 31 turns the cam 32 in the direction of the arrow 34 of FIG. 5. FIG. 6 illustrates what the opening aid 30 does next.

Upon rotation 34 of the cam 32, the maximum point on the cam control surface 36 meets an opposing control surface 21 on the pawl 20, which is then pivoted in opposition to its spring-loading 29 away from the latch 15. The pawl 20 moves from its main latching position 20.3, still present in FIG. 5, into a releasing position 20.4 in FIG. 6. In the releasing position 20.4, the catch projection 27 has released the main latching notch 17 of the latch 15, but it has also been pivoted back so far from the prelatching notch 16 that the prelatching notch 16 can now also move safely past the catch projection 27, as shown by the dotted arrow 23.

In FIG. 6, the latch 15 is in an intermediate position, indicated by the auxiliary line 15.5. In comparison with the completely engaged position of FIG. 5, the closing stirrup 10 has already moved back somewhat relative to the lock 12 in the direction of motion arrow 51 of FIG. 6. The spring-loading action of the spring provided there, present between the hatchback 18 and the body of the vehicle 38, has already relaxed somewhat. During this relaxation, however, the closing aid 40 is also cooperating in a special way, which is to be described on the basis of FIGS. 5 and 6. Now the previously mentioned second function of the actuator comes into play.

The second function of the actuator proceeds from the main latching position 35.3 of the latch in FIG. 4 and consists in now also acting on the closing aid 40, first turning its motor 41 a short distance in the direction of the closing movement described in conjunction with FIG. 2. The transmission mechanism 43, 44 is moved in the direction of the closing movement 45 of FIG. 2. The transmission mechanism 43, 44 thus executes the further movement illustrated by the motion arrow 50 in FIG. 5. The coupling 42 again arrives in the coupling position 48.2 of FIG. 5. A certain tension is built up between the (sliding) block 48 and the inner stop 49 of the block guide 47. This is the first change to be achieved versus the previous situation of FIG. 4.

Another difference with respect to FIG. 4 consists in that, upon continuation of the movement 50, the transmission rods 43, 44 also turn the rotary latch 15 farther out of its main latching position 15.3 of FIG. 4 against its spring-loading 19 by an angle 52. The latch thus arrives in a position, illustrated by the auxiliary line 15.4 in FIG. 5, which is to be called the “overstroke” position. As can be seen in FIG. 5, the pawl 20 remains initially in its main latching position 20.3 shown in FIGS. 3 and 4, where the support projection 28 of the pawl 28, as a result of its spring-loading 29, is supported on the periphery of the rotary latch 15. A gap 53 is created between the catch projection 27 of the pawl 20 and the main latching notch 17, as can be seen in FIG. 5. In the overstroke position 15.4 of FIG. 5, the elastic forces of the seals or the like, which act between the rotary latch 15 and the closing stirrup 10, are no longer transmitted to the pawl 20 but rather are absorbed initially by the motor 41 of the closing aid 40, acting via the transmission mechanism 43, 44. The pawl 20 is free of load and can therefore be moved easily into the previously described releasing position 20.4 of FIG. 6 by the actuator and, in the present case, by the opening aid 30.

In the previously described releasing position 20.4 of the pawl 20 in FIG. 6, however, the special return phase of the closing aid 40, already mentioned above, takes place. As can be seen from the tension position of the coupling 42 illustrated by the auxiliary line 48.2 in FIG. 2, the latch 15 is also engaged and held under tension by the transmission rods 43, 44. In addition to the latch's own spring loading 19, the elasticity of the seals between the hatchback 18 and the vehicle body 38 are also acting on the latch 15. The motor 41 of the closing aid 40 now goes into action in the direction opposite that of the closing phase 45 described in conjunction with FIG. 2. What happens is a return movement of the transmission mechanism 43, 44 and thus of the latch 15 as illustrated by the arrow 46 in FIG. 6.

As previously mentioned, an intermediate position 15.5 of the latch 15 is reached in FIG. 6. The latch 15 is then turned even farther in the direction of the previously mentioned arrow 22 toward the open position shown in FIG. 1. What occurs is a gradual return movement 22, which is carefully controlled by the motor 41 of the closing aid 40, now acting in the direction of the arrow 46. The compressed seals between the hatchback 18 and the vehicle body 38 can relax slowly. The rotary latch 15 is also returned by the spring-loading 19 to its open position 15.1 of FIG. 1. The lock 12 has been opened without any noise at all.

When the hatchback 18 is opened, the opening aid 30 operates in the manner described, but in addition the closing aid 40 also makes a significant contribution to this process. To obtain this special cooperation between the opening aid 30 and the closing aid 40, all that is required is suitable software and an electrical control unit to manage the interaction of these two devices 30, 40. In terms of hardware, the invention can also make use of the components already present in such mechanisms in any case, namely, the opening aid 30, the closing aid 40, and the actuator.

While specific embodiments of the invention have been shown and described in detail to illustrate the inventive principles, it will be understood that the invention may be embodied otherwise without departing from such principles.

We claim:

1. A closing mechanism with a movable part of a vehicle such as a (hinged) lid or door and with a resting part of the vehicle, namely, the vehicle body,
comprising of a lock on one part of the vehicle and a closing part on another part;
where the lock comprises a rotatably supported latch and a pivotably supported pawl;
the latch has a receptacle for a closing part and both a prelatching notch and a main latching notch for the engagement of the pawl;
the pawl is spring-loaded in the direction toward the latch; and
the latch is in an open position when the (hinged) lid or door is open, and, when the (hinged) lid or door is being closed, the latch moves initially into a prelatching position, in which the pawl engages in the prelatching notch of the latch;
with a motorized closing aid, which, during the closing phase, moves the latch by motor power onward out of the prelatching position, thus bringing the latch into the main latching position, in which the pawl is supported on the main latching notch of the latch; and
with an actuator, acting on the pawl, to open the (hinged) lid or door;
where, upon activation of the actuator, the pawl is lifted out of the main latching notch, which thus releases the latch; and the released latch leaves its main latching position and returns to its open position, in which the (hinged) lid or door is open, wherein
while the latch is in the main latching position closed, the closing aid is activated again before the release or during the release of the latch by the pawl and, during the return movement phase, moves the latch gradually back into its open position in the direction opposite that of the preceding closing phase.

2. The closing mechanism according to claim 1, wherein, before the return movement phase is initiated, the closing aid, first executing an overstroke phase, moves the latch onward in the same direction as that of the preceding closing phase out of its main latching position and into an overstroke position, thus creating a gap between the main latching notch of the latch and the catch projection of the pawl; and where, only after that, does the closing aid, acting in the direction opposite that of the overstroke phase, execute the return movement phase of the latch.

3. The closing mechanism according to claim 1, wherein the closing aid is in a relaxed neutral position when the latch is in the completely open position and/or in the full main latching position.

4. The closing mechanism according to claim 2, wherein, before the latch leaves the main latching position, the closing aid first arrives in a tensioned position so that it can execute the overstroke phase, after which it executes the return movement phase.

5. The closing mechanism according to claim 3, wherein a transmission connection is present between the latch and the closing aid; and where the transmission connection is disengaged when the latch is in the completely open position and/or in the full main latching position.

6. The closing mechanism according to claim 4, wherein the transmission connection between the latch and the closing aid is engaged before the latch leaves the main latching position; and where the closing aid first executes the overstroke phase and then the return movement phase.

7. The closing mechanism according to claim 1, wherein, when in the completely open position and/or in the full main latching position, the latch is held under tension by the closing aid.

8. The closing mechanism according to claim 1, wherein the latch is spring-loaded in the direction toward the pawl.

9. The closing mechanism according to claim 1, wherein the pawl is lifted out its engagement with the main latching notch of the latch by a motorized opening aid; and where the actuator activates the opening aid.

10. The closing mechanism according to claim 9, wherein the opening aid comprises a driven cam, the control surface of which cooperates with an actuating surface on the pawl; and where the cam, driven by the motor, moves the pawl out of its latching position at the main latching notch and into a releasing position, in which the latch is released.

11. The closing mechanism according to claim 1, wherein, although the closing aid is located outside the lock, it is connected to the latch in the lock by a mechanical transmission mechanism.

12. The closing mechanism according to claim 1, wherein the closing aid is integrated into the lock.

13. The closing mechanism according to claim 1, wherein, although the closing aid normally remains inactive when the latch is in the main latching position, it becomes active again upon actuation of the actuator.

14. The closing mechanism according to claim 13, wherein, when the actuator is actuated, the closing aid executes its overstroke phase first and then executes the return movement phase of the latch.

15. The closing mechanism according to claim 1, wherein, although the closing aid remains inactive while the vehicle is being driven, it is shifted, when the vehicle is stopped, into a standby position, in which it can respond to the actuation of the actuator.

16. The closing mechanism according to claim 1, wherein the return movement phase of the closing aid is controlled by at least one sensor, which responds to the position of the lock elements in the lock.

17. The closing mechanism according to claim 16, wherein the sensor works without contact by capacitive, electromagnetic, acoustic, and/or optical means and controls the closing aid during its return movement phase.

18. The closing mechanism according to claim 1, wherein the actuator is a component of an ID transmitter such as an electronic key, which, when actuated, executes the overload phase and/or the return movement phase of the closing aid.

19. The closing mechanism according to claim 1, wherein, during its return movement phase, the closing aid, moves the latch back into the area of the open position.

20. The closing mechanism according to claim 1, wherein, during its return movement phase, the closing aid moves the latch back into the area of the prelatching position and then deactivates itself or assumes a neutral position.
